(19) United States
(12) Patent Application Publication
(10) Pub. No.: US 2023/0172231 A1
(43) Pub. Date: Jun. 8, 2023

(54) ANIMAL FEED COMPOSITION

(71) Applicant: YOUNIKAT GMBH, Munich (DE)

(72) Inventors: Tessa ZAUNE-FIGLAR, Munich (DE); Valerie HENSSEN, Munich (DE)

(21) Appl. No.: 17/920,438

(22) PCT Filed: May 6, 2021
(86) PCT No.: PCT/EP2021/062083

§ 371 Date: Oct. 21, 2022

(30) Foreign Application Priority Data
May 6, 2020 (DE) 10 2020 205 726.5

(51) Int. Cl. A23K 10/30; A23K 20/142; A23K 50/40; A23L 13/40; A23J 3/14

(52) U.S. Cl. CPC A23K 10/30; A23K 20/142; A23K 50/40; A23L 13/426; A23J 3/14

(57) ABSTRACT

An animal feed composition includes: 5 to 60 weight % protein relative to the dry weight of the composition, which comprises protein obtained from the family of the duckweeds (Lemnaceae), 0.5 to 65 weight % carbohydrates relative to the dry weight of the composition; and 0.001 to 5 weight % fiber relative to the dry weight of the composition.

### CROSS-REFERENCE

This application is the US national stage of International Patent Application No. PCT/EP2021/062083 filed on May 6, 2021, which claims priority to German Patent Application 10 2020 205 726.5 filed on May 6, 2020.

### TECHNICAL FIELD

The invention relates to a plant-based animal feed composition, to a manufacturing method thereof, and to a method of using the animal feed.

### BACKGROUND

In general, the term “animal feed” denotes (encompasses) all types of animal nutrition. In the classification of animal feeds based on their contents, a distinction is made, for example, between green fodder, protein-rich feed, oil-containing feeds, special feeds, and complete feeds. According to European Regulation (EC) No. 767/2009 Art. 3 (2)(i), a complete feed is defined as a “compound feed which, by reason of its composition, is sufficient for a daily ration.” Depending on the type, age, and use, animals can be fed with all necessary nutrients using a complete feed. Complete feeds are therefore characterized by the precise balancing of all the ingredients used and of the processing procedure for the animal to be fed, and thus by an exact fulfilment of the nutrient-, trace-element-, vitamin-, and mineral-requirements for the animal, as well as by having a suitable consistency. In particular, in the context of feeds in the house pet sector, a precise knowledge of the requirements of the particular animal species is required in order to avoid both an under- and an over-feeding of nutrients. This is important above all with respect to protein-containing complete feeds, wherein the precise knowledge of the protein- or amino-acid-requirements of the animal and of the amino-acid availability of the feed enables the formulation of correspondingly adapted rations. The protein requirement of an animal is defined here as the minimum intake of protein that promotes optimal growth and health. Here this minimum intake ensures in particular the supplying (of nitrogen and) of essential amino acids.

In the known animal feed compositions, proteins primarily of animal origin are disadvantageously used. This is disadvantageous above all in light of the CO₂ emissions associated with animal husbandry and meat production. Furthermore, in view of the trend in the food industry of using animal byproducts not for the production of animal feed, but rather for the production of food products for humans, fewer animal-based protein sources are available for animal feed production. For example, chicken collagen is used for the production of sausage products (Munashinge 2015), and porcine collagen is used for improving the quality of smoked ham (Schilling et al., 2003). Byproducts made of shrimp are used as nutritional supplements (Bueno-Solano et al., 2009). For the production of animal feed for pets, various protein sources are often combined in order to improve the overall quality and the amino-acid profile (Zekic, 2012), wherein in particular poultry- and fish-meal are used.

Duckweeds (Lemnaceae) are ubiquitously occurring, free-floating water plants that find use in a variety of fields: for example, in wastewater treatment, in the production of biopharmaceutical products, and as feed additives in the field of the commercial breeding of poultry, pigs, and fish. The family of the Lemnaceae comprises the subfamilies Wolffioideae and Lemnoideae, which in turn are subdivided phylogenetically into five genera: the subfamily Wolffioideae comprises the genera Wolffia and Wolffiella; the subfamily Lemonideae comprises the genera Lemna, Landoltia, and Spirodela (Les et al., 2002). Common to all genera is a high nutritional value, wherein the raw protein content can fall between 20% and 45% of the dry weight depending on the culturing conditions (Appenroth, 2017). The protein content can be increased in particular by using a high ammonium salt content in the culturing. In contrast to protein from other plants, duckweeds are, generally speaking, rich in many essential amino acids and can contain up to twice the amount of these, which has been codified by the Food and Agriculture Organization (FAO) as the standard for healthy nutrition (based on humans). In particular, the essential amino acids lysine, threonine, valine, leucine, and phenylanaline are found in duckweeds (Appenroth and Augsten 1996). Duckweeds are thus very similar to proteins of animal origin. However, the various genera differ in their anatomical, biochemical, and genetic features, as well as with respect to their growth rate; even the different species within a genus in some cases have significant differences with respect to protein-, starch-, and fat-content, and fiber content (Appenroth, 2018). The plants can be cultivated in an economical and resource-friendly manner: in comparison to the cultivation area required for producing a defined amount of protein from soy, only approximately one-tenth of the cultivation area is required for duckweeds (Appenroth and Augsten, 1996).

Various methods are available for the determination of the value of a protein, for example, the Amino Acid Index (AAI) (also: Chemical Score, CS), in which the content of each individual essential amino acid in the dietary protein is compared to the content of the corresponding amino acid in a reference protein. The more similar the dietary protein is to the reference protein, the higher the score value, and the value of the dietary protein. Here the so-called “limiting amino acid” is the amino acid having the lowest score value. Since the AAI does not take into account the different actual digestibility of the respective protein, the protein quality is calculated according to the recommendations of the WHO using a corrected amino acid index, i.e., the so-called PDCAAS method (PDCAAS=Protein Digestibility Corrected Amino Acid Score). Here the AAI is corrected by the actual digestibility (protein digestibility, PD) of the dietary protein: PDCAAS=AAI*PD. The latest variant of the PDCAAS is the DIAAS (Digestible Indispensable Amino Acid Score), in which the digestibility in the entire intestinal tract is not taken into account, but rather only the ileal digestibility. Here the proteins produced by the microflora in the large intestine as well as the bacterial fermentation in the colon are corrected for (FAO, 2013).

### SUMMARY

In animal feed compositions according to the present disclosure, a plant-based protein source is advantageously used that is similar to an animal-based protein source with respect to the corrected amino acid index and the amino acid digestibility, or does not differ from it. By suitably selecting additional, non-protein components to be added to the animal feed composition, it is ensured in particular that a largely complete absorption of the dietary protein is ensured, and the amount of antinutrients is greatly limited. In particular, such an animal feed composition enables a simple and cost-effective adaptation to the individual nutritional requirement of animals, as is given, for example, based on a specific breed. Such an animal feed composition can also be adapted in a simple manner to different nutritional requirements, for example, during growth, during pregnancy, or in old age, and/or to the existence of digestive, resorption, or metabolic disorders.

In a first aspect of the present disclosure, an animal feed composition comprises 5 to 60 weight % of protein based on the dry weight of the composition, wherein the protein content comprises protein obtained from the family of the duckweeds (Lemnaceae). The animal feed composition further comprises 0.5 to 65 weight % carbohydrates based on the dry weight of the composition, and 0.001 to 5 weight % fiber based on the dry weight of the composition.

As noted above, such an animal feed composition advantageously has a protein content that includes protein obtained from the family of the duckweeds (Lemnaceae). The Lemnaceae are a subfamily of the aroids (Araceae). Duckweeds belong to the smallest seed-bearing plants in the world. For example, the smallest plant (Wolffia arrhiza, rootless duckweed) in the duckweed family is less than 1 mm in size in the mature state. Duckweeds bloom very rarely and usually propagate vegetatively by budding, wherein under favorable conditions they can double their biomass within two days. Lemnaceae live free-floating on or slightly beneath the water surface of standing waters. The family of duckweeds contains a tribe (i.e., a category in biological classification between family and genus), namely the tribe Lemneae. This is divided into five genera having approximately 37 species: Lemna having approximately 13 species that are distributed worldwide; Spirodela having two species; Landoltia; Wolffia having approximately 11 species distributed worldwide, as well as Wolffiella, whose approximately 10 species are found in America and Africa.

The specifications of weight percentage, weight %, refer to the number of grams (or kg) of a substance that is contained in 100 g (or kg) of a mixture. In the present specification, all weight percentages are made with reference to the dry weight of the animal feed composition.

In particular, the protein content of animal feed compositions according to the present disclosure consists of high-quality plant proteins. In particular, the protein content in duckweed plants is high and can fall between 20-45% of the dry weight depending on the growth conditions. In particular, the amount of the essential amino acid lysine in all Lemnaceae species is higher than the amounts in conventional meals made from wheat, maize, or rice. The present animal feed compositions can be used both as wet feed (water proportion between 50-80%) and as dry feed (water proportion between 5-15%), wherein the solubility in water is excellent. The content of fiber ensures above all, in addition to a good chewability of the inventive animal feed composition, a stable and healthy digestibility of the composition. Owing to the presence of the duckweed protein, the processability of the animal feed composition is also particularly favorable with respect to processing effort and costs.

In an advantageous further development of the above-mentioned animal feed composition, 1 to 99 weight % of the protein content of the animal feed composition can consist of protein from duckweeds. Such a composition is advantageously characterized by a high-quality protein content. In particular, 1 to 99 weight % of the protein content can advantageously consist of duckweed ribulose-1,5-bisphosphate carboxylase/oxygenase (RuBisCO). RuBisCO is an important enzyme for carbon dioxide fixation in plants, and is responsible for the uptake of carbon dioxide in all photosynthetically active plants and bacteria. Owing to the growth of duckweeds in water, resources can be economically and sustainably used, and agricultural land can be conserved.

In a preferred embodiment, <50 weight % of the protein content of the animal feed can consist of protein concentrate from duckweeds, and >50 weight % of the protein content can comprise one or more plant-based, non-duckweed protein sources, and/or one or more animal protein sources and/or protein from pillar fungi species (Basidiomycota) and/or from in vitro meat. In particular, when the protein content of the animal feed, which includes or consists of a protein concentrate from duckweeds, accounts for <50 weight %, the product is characterized by excellent properties with respect to consistency, taste and protein digestibility. If necessary, the animal feed can be substituted with plant-based or animal protein sources. Alternatively, proteins from pillar fungi species (Basidiomycota), which include up to 30,000 different species, can be used. The three edible mushroom species Agaricus bisporus, Lentinula edodes, and Pleurotus ostreatus are among the most widely cultivated mushrooms of this group worldwide. Basidiomycota are rich in protein and carbohydrates, have a low fat content, and are a good source for minerals. Due to their differentiated enzyme system, mushrooms from the group Basidiomycota can advantageously decompose a wide variety of organic waste materials and thus, for example, complex structures such as lignin can be used after the decomposition for their metabolism. It is particularly advantageous when pillar fungi species, which are utilized with the present animal feed compositions, are characterized by a balanced amino acid composition and contain all essential amino acids. It is furthermore advantageous when the protein pillar fungi species involves mycelia protein. Mycelia protein can be obtained from cultivated mycelium cells. For example, mycelia of different mushrooms can be fed in a controlled environment with byproducts or waste products from industrial and agricultural processes, wherein, for example, sugar cane, rice husks, and spent grains can be waste products used as a food source for mycelia in such processes. In bioreactors, the mycelium cells ferment the byproducts and multiply, whereby a protein-rich biomass develops that can in turn be used in various products.

In a further preferred embodiment, proteins from molds, for example, Aspergillus flavus var. oryzae, can supplement the protein content in animal feed compositions according to the present disclosure.

In vitro meat, which is also known as cultivated meat, involves meat that is produced by in vitro cell culture from animal cells instead of from slaughtered animals. In vitro meat thus belongs to the so-called “cellular agriculture.” Cultivated meat is manufactured using tissue engineering techniques that are used in conventional regenerative medicine. Resource-friendly cultivated meat can advantageously replace real meat in order to conserve natural resources (land consumption, monoculture, etc.).

In a preferred further development of the animal feed composition, 1 to 99 weight % of the protein content of the animal feed can consist of protein from duckweeds, and additionally can comprise protein from pillar fungi species (Basidiomycota) or molds and/or in vitro meat. In particular, when the protein content of the animal feed that consists of a protein concentrate from duckweeds is supplemented by further protein sources having a defined amino acid profile, such as, for example, after supplementing using protein from cultured fungi products or from in vitro meat, the product is characterized by excellent properties with respect to consistency, taste, and protein digestibility.

In a preferred implementation, the composition can be a plant-based animal feed composition. A plant-based animal feed composition is advantageously manufacturable in large quantities in a resource-friendly manner.

In a further embodiment, the composition can have a corrected Amino Acid Index (AAI) of at least ≥0.9, preferably at least ≥0.95. The (uncorrected) Amino Acid Index (or also “Chemical Score”) is calculated by a comparison of the protein to be evaluated (test protein) to a reference protein that can, in principle, be freely selected. However, in order to obtain a meaningful AAI for a certain test protein, it is necessary to choose a reference protein that actually corresponds to the requirement of the organism to be nourished. The AAI is calculated according to

$$AAI = ( \{ … , \frac{\% Content {AA}_{i , T}}{\% Content {AA}_{i , R}} * 100 , … \} ) .$$

wherein AA_{i,T}=amino acidᵢ or amino acid groupᵢ in the test protein T with 1≤i≤n, AA_{i,R}=amino acidᵢ or amino acid groupᵢ in the reference protein R with 1≤i≤n, and n=number of amino acids or amino acid groups in the reference protein.

To determine the corrected Amino Acid Index, the Amino Acid Index is corrected with respect to the digestibility of the protein according to

corrected Amino Acid Index=AAI×true digestibility.

The corrected amino acid index is customarily referred to as the Protein Digestibility-Corrected Amino Acid Score (PDCAAS). The true digestibility of an ingested protein is determined based on the nitrogen contained therein, i.e., the digestibility refers to the ratio of absorbed nitrogen to ingested nitrogen. However, since the absorbed nitrogen cannot be directly measured, it is calculated from the difference between ingested and fecally eliminated nitrogen, i.e., according to

$$true digestibility = \frac{{N}_{ing , T} - ( {N}_{fec , T} - {N}_{fec , R} )}{{N}_{ing , T}}$$

wherein N_{ing,T}=ingested nitrogen of the test protein, N_{fec,T}=fecally eliminated nitrogen of the test protein, and N_{fec,R}=fecally eliminated nitrogen in a protein-free reference diet. In the determination of the true digestibility, the proteins produced by the microflora in the large intestine, the endogenous protein secretion in the gastrointestinal tract, and bacterial fermentation in the large intestine are also taken into account. The animal feed composition advantageously has a corrected Amino Acid Index that falls in the range of animal protein products, wherein, for example, chicken whole-egg protein, cow's milk, and casein, for example, each have a (truncated) corrected amino acid index of 1, and the corresponding indices of chicken or beef fall at respectively 0.95 and 0.92. In contrast, the corrected Amino Acid Index of soy or isolated pea protein concentrate, fall at 0.91 and 0.89 respectively. The animal feed composition is advantageously characterized by a defined protein content of high quality, wherein the plants, which supply this content, simultaneously produce large amounts of protein under defined growth conditions.

In a further embodiment, the apparent protein digestibility of the composition can be at least ≥70%, preferably ≥80%, and in particular preferably ≥85%. The apparent digestibility is calculated from:

$$apparent digestibility = \frac{{N}_{ing , P} - {N}_{fec , P}}{{N}_{ing , P}}$$

wherein N_{ing,P}=ingested nitrogen of the protein, and N_{fec,P}=fecally eliminated nitrogen of the protein. The apparent protein digestibility of animal products, such as for example, of chicken eggs or milk/cheese, correspondingly falls at 0.97 and 0.98, respectively. Oat flakes, maize, or beans are characterized by an apparent protein digestibility of 0.86, 0.85, and 0.78, respectively. The apparent protein digestibility is also referred to as “apparent fecal digestibility,” i.e., “AFD”. For commercially available, meat-based dry food for adult dogs, the AFD is estimated to be in the range of approximately 80% (range: 71-92%, Hervera, 2001; 78.1-83.9%, Hendricks 2013). The apparent digestibility of animal feed compositions according to the present disclosure advantageously falls above the values for commercially available dry meat-based food.

In one preferred further development, the protein from duckweeds in the animal feed composition can be selected from a group consisting of isolated duckweed protein, duckweed protein concentrate, duckweed protein isolate, duckweed protein-hydrolysate, unprocessed, ground, or crushed duckweeds, or combinations thereof. Protein concentrates are obtained by ultrafiltration of the unheated starting product; here the protein content falls, for example, between 70 to 80%. Protein isolates have a much higher protein content of up to 95%, since they must be processed with a smaller pore size in the ultrafiltration. Alternatively to microfiltration, ion exchange technology is available with approximately the same yield of proteins, wherein disadvantageously a series of chemical substances must be added and subsequently removed again. Protein hydrolysate is produced based on a protein-concentrate or -isolate by chemical or enzymatic hydrolysis. Protein hydrolysates are considered particularly well digestible due to the decomposition into individual amino acids. The proteins from duckweeds can advantageously be adapted to the needs of the animal with respect to their concentration in animal feed compositions according to the present teaching by appropriately selecting of the manner of preparation (e.g., different protein content for old and young animals, and/or different protein processing in the cases of food intolerances or allergies).

In a preferred embodiment, the duckweed protein, the duckweed protein concentrate, the duckweed protein isolate, the duckweed protein hydrolysate, the unprocessed, ground, or crushed duckweeds, or combinations thereof can be used in the animal feed composition as a decolorized (bleached, colorless) ingredient. Suitable methods for the bleaching of foodstuffs, in particular of plant-based foodstuffs, for example, cooking with or without bleaching agent (for example, sodium bicarbonate), or treatment with steam, are known to the skilled person. In a further embodiment, the duckweed protein, the duckweed protein concentrate, the duckweed protein isolate, the duckweed protein hydrolysate, the unprocessed, ground, or crushed duckweeds, or combinations thereof can be used as an odorless ingredient in the animal feed composition. Here the odor can be determined using sensory analysis, for example, using static or dynamic olfactometry (DIN 10950). In particularly preferred embodiments, depending on their sensory characteristics the duckweed-based ingredients can be present in the animal feed composition as colored or decolorized, odorless or not odorless, or combinations thereof. The protein content, which originates from duckweeds, of the animal feed compositions according to the present disclosure is advantageously colorless and odorless in order to provide appropriate sensory characteristics for the animal owner.

In a further implementation, at least some of the protein in the animal feed composition can originate from duckweeds of the genus Lemna, Wolffiella, or Wolffia, or combinations (hybrids) thereof. In particular, the genera Wolfiella and Wolfia are characterized by a high content of essential amino acids while also having high growth rate (Appenroth 2017).

In a preferred embodiment, such protein can originate from duckweeds from hybrids (for example using classical breeding or gene editing) of members of different genera, for example, the crossing of Landoltia punctata with Lemna minor L., or the crossing of two different species of Lemna gibba G3. Using the examination of heterosis (improved performance of hybrids of the first filial generation (F1) in comparison to the average performance of the parental generation), the skilled person is in the position to carry out suitable duckweed crossings, wherein the filial generation is characterized in particular by improved flowering ability and seed production (assessment criteria). The clones required therefor can be found in the database of the Rutgers Duckweed Stock Cooperative, i.e., “RDSC” (http://www.ruduckweed.org/).

In a preferred development, the animal feed composition can additionally comprise 1 to 10 weight % of a fat. The fat can particularly preferably be selected from one or more plant-based oils, such as sunflower oil, algae oil, chia seed oil, sesame oil, evening primrose oil, pumpkin seed oil, grapeseed oil, sallow thorn oil, rose hip kernel oil, argan oil, black caraway oil, borage oil, apricot kernel oil, almond oil, peanut oil, linseed oil, linseed crush, camelina oil, olive oil, rapeseed oil, corn oil, hazelnut oil, hempseed oil, rice germ oil, sesame oil, safflower oil, soybean oil, palm oil, coconut oil, walnut oil, or combinations thereof. In addition or in the alternative, animal fats can originate from the tissue of mammals, poultry, and fish, such as, for example, beef tallow, pork lard, poultry fat, and fish oil. In conventional pet foods, fats are the main source of energy for the animal and promote the absorption of fat-soluble vitamins. They also provide important precursor molecules in the synthetic pathway for eicosanoids and prostaglandins, and act as flavor enhancers. In particular, fats are necessary for the provision of essential fatty acids, i.e., fatty acids that have one or more double bonds at higher positions than C9 (counted starting from the carbonyl carbon) and that the animal, which eats the animal feed composition, cannot produce itself. The animal feed composition preferably comprises omega-6 and omega-3 fatty acids, such as linolenic acid (18:2) and arachidonic acid (20:4) as omega-6 essential fatty acids, and alpha-linolenic acid (18:3), eicosapentaenoic acid (20:5) and docosahexaenoic acid (22:6) as omega-3 fatty acids.

In a further embodiment, the animal feed composition can additionally comprise 0.01 to 3 weight % of a mineral supplement. Here, by way of example, the mineral supplement may comprise one or more of the vitamins A, D3, E, B1, B2, B6, B12, biotin, niacin, and pantothenic acid, as well as, for example, copper (as copper acetate), calcium, phosphorous, manganese (as manganese sulfate), zinc (as zinc sulfate), iodide (as potassium iodide), as well as iron (as iron fumarate).

In a preferred implementation, the animal feed composition can additionally comprise 0.01 to 2.0 weight % amino acids. For example, the group of amino acids may comprise proteinogenic amino acids and non-proteinogenic amino acids, as well as essential nutrients, such as, for example, taurine and carnitine. In particular, the amino acids can preferably be selected from the group consisting of cysteine, methionine, threonine, tryptophan, or combinations thereof. Individual amino acids can advantageously be supplemented in a targeted manner, since, for example, the ideal digestibility for some amino acids can vary significantly depending on other food components and the type of preparation (heating) (Hendriks, 2015). The ideal digestibility of cysteine varies, for example, by 29-69% in a manner directly depending on the heat used in the preparation of the food (crosslinking within proteins; Deb-Choudhury et al., 2014)

In a preferred further development, the animal feed composition can further comprise a protein selected from the group consisting of a wheat protein, a rye protein, a barley protein, an oat protein, a rapeseed protein, a lupine protein, a pea protein, a rice protein, a soy protein, a millet protein, an amaranth protein, an arrowroot protein, a chia protein, a buckwheat protein, a manioc protein, a chickpea protein, a peanut protein, a potato protein, a sunflower protein, a tapioca protein, or combinations thereof. Additional proteins from the above-mentioned sources can advantageously be added in order to ensure an optimal adaptation of the animal feed composition depending on, for example, the age of the animal, the physiological requirements (growth, pregnancy), certain pathological conditions (allergy, food intolerance), and/or on differences necessitated by the breed (e.g. Mansilla et al., 2018, investigation of different dog breeds).

In a further embodiment, the carbohydrates in the animal feed composition can be selected from cereals and/or pseudocereals, and in particular can be selected from the group consisting of buckwheat carbohydrate, spelt carbohydrate, amaranth carbohydrate, quinoa carbohydrate, wheat carbohydrate, millet carbohydrate, rye carbohydrate, barley carbohydrate, oat carbohydrate, maize carbohydrate, rice carbohydrate, potato carbohydrate, and combinations thereof. Here a pseudocereal is understood to mean a cereal from grain crops of plant species that do not belong to the sweet grass family (=all true cereal species), but are used in a similar manner as a true cereal. Seeds of pseudocereals are advantageously gluten free. Vegetables such as, for example, black beans, lima beans, broccoli, cauliflower, etc. are advantageously rich in insoluble fiber. Carbohydrates from the above-mentioned sources can advantageously be selectively used in animal feed compositions according to the present disclosure in order to ensure an optimal adaptation of the composition depending, for example, on the age of the animal, the physiological requirements (growth, pregnancy), certain pathological conditions (overweight, allergy, food intolerance), and/or on differences necessitated by the animal breed.

In a second aspect of the present disclosure, a method for manufacturing the animal feed composition as described above may comprise mixing protein obtained from the family of the duckweeds (Lemnaceae) with carbohydrates, preferably with cereal- and/or potato-carbohydrates, and with fiber, preferably with vegetable fiber, in a liquid phase. In a preferred embodiment, the process is supplemented by the steps: optional addition of amino-acid-optimized protein from pillar fungi species (Basidiomycota) or mold species, and/or of in vitro meat, optionally followed by the step of increasing the dry matter of the liquid phase, optionally followed by the addition of amino acids in a liquid phase and the obtaining of a liquid composition, optionally followed by the addition of water-soluble minerals to obtain a supplemented composition; optionally followed by the addition of fat and the subsequent homogenizing with the liquid or supplemented composition; and optionally followed by the step of drying the liquid composition or the supplemented composition. The mixture of the basic substances protein, carbohydrates, fiber is effected in the liquid phase and thus inherently enables a simple production of the feed with a low liquid content (step b). If an addition of amino acids is required, they can also be added in a liquid phase, so that a uniform mixing with the basic substance can be effected. Compatibility problems between the individual components, in particular the amino acids and the mixture from step a), are thus avoided.

A third aspect of the present teachings involves the use of an animal feed composition comprising 5 to 60 weight % protein relative to the dry weight of the composition, further comprising protein obtained from the family of the duckweeds (Lemnaceae), wherein a corrected amino acid index is at least 0.9; furthermore comprising 0.5 to 65 weight % carbohydrates relative to the dry weight of the composition, and 0.001 to 5 weight % fiber relative to the dry weight of the composition, as a complete food for pets. According to the present disclosure, the term “pets” is intended to encompass all animals that are not subjected to agricultural use and do not serve for the benefit of food production (in contrast to livestock in the agricultural sector, for example, for fattening or milk production). Pets according to the present disclosure can thus also include livestock, for example, sheep, goats, and the like, when they are not used for agriculture. The animal feed composition is further suited to be used as a complete feed for wild animal species kept in zoological facilities (zoo animals). According to the present disclosure, pets thus also include in particular amphibians, arachnids, insects, invertebrates, and fish. In a preferred further development, the composition can be suitable as a complete feed in particular for small animals, namely for cats and dogs. Here, complete feeds are defined as feeds that supply the animals with all necessary nutrients depending on their species, their age, and use, and for which only water need be provided. Complete feeds are characterized by a precise balancing of all the ingredients used and the processing procedure for the animal, and thus an exact fulfilment of the nutrient-, trace-element-, vitamin-, and mineral-requirements, as well as a suitable consistency.

In a preferred embodiment, the composition can be suitable as a complete feed for pets (i.e., including birds, reptiles, arachnids, insects, amphibians, invertebrates, and fish), and wild animals that are kept in zoological facilities, in particular as a complete feed for house pets and small animals. Here, house pets are, for example, rabbits and rodents; dogs and cats are counted as small animals.

As used herein, ingredients are preferably specified in weight %.

### BRIEF DESCRIPTION OF THE FIGURES

FIG. 1 shows an example of an animal feed composition according to the present disclosure separated by categories of nutrients of a vegetarian wet food for dogs.

FIG. 2 shows the results of a feeding test. More particularly, FIG. 2 shows the assessment of the sensory characteristics of the test food fed by the animal owner on a scale of 1=very good to 5=unsatisfactory, wherein smell, consistency, handling of the food, as well as the assessment of the composition were evaluated.

FIG. 3A shows observations of food consumption with respect to the factors: refusal of the food, significantly reduced consumption, reluctant consumption, cautious appetite, large appetite, ravenous appetite.

FIG. 3B shows the tolerability of the food using assessment of the stool consistency and the frequency of defecation, as recorded by the animal owner. Recorded parameters: “d”-diarrhea, “w”-softer consistency than with the usual diet, “n”-normal consistency, and “h”-harder consistency than with the normal diet.

### DETAILED DESCRIPTION OF THE INVENTION

The exemplary embodiments presented below serve only for illustration and do not limit the scope of the invention as set forth in the claims. In the above and subsequent paragraphs, the term “a”/“one” means “one/one or more” unless indicated otherwise.

The exemplary embodiments relate to animal feed compositions for the pet sector, in particular for the small animal sector, and in particular dog food; in particular, however the animal feed compositions according to the present teachings are also suitable for other mammals in the pet sector, for example, as well as for reptiles, birds, arachnids, insects, invertebrates, and fish. Animal feed compositions according to the present teachings are furthermore suitable for wild animal species kept in zoological facilities. In particular, the exemplary embodiments relate to house pets, such as, for example, rabbits, dwarf rabbits, rodents, such as, for example, hamsters, guinea pigs, mice, and in particular small animals (dogs and cats).

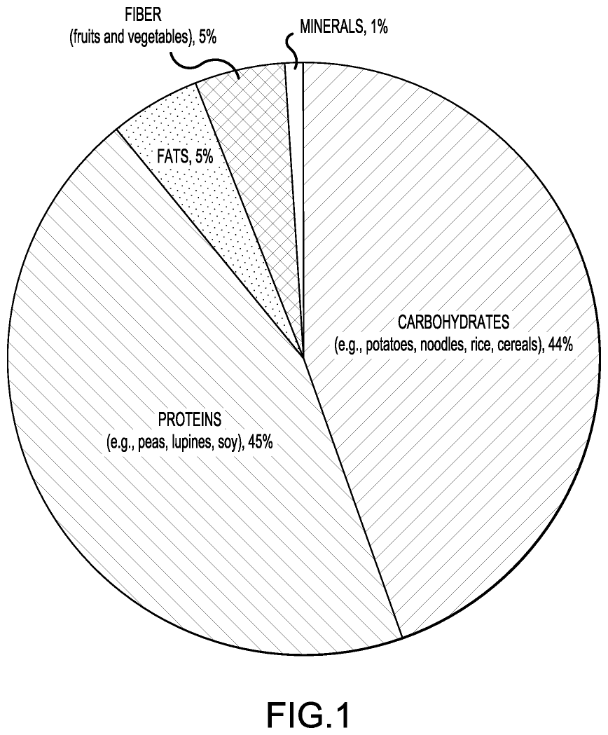

The exemplary embodiments relate to both wet and dry feed. One example for the composition according to categories of nutrients of a vegetarian wet food for dogs is shown in FIG. 1.

### Exemplary Embodiment I: Vegetarian Wet Food for Dogs

The exemplary embodiment I shows a summary of the ingredients for a vegetarian wet food that is suitable for adult dogs.

| Ingredients: | % |
|---|---|
| Duckweed protein | 2.50 |
| Whole egg powder | 2.50 |
| Oat flakes | 31.00 |
| Lentils | 50.00 |
| Sunflower oil | 4.00 |
| Algae | 1.00 |
| Spinach | 5.00 |
| Mineral mixture | 3.00 |
| Ground sunflower seeds | 1.00 |

The composition can comprise, for example: vegetables (14% potatoes, 3% carrots, 3% zucchini, 3% lupines, 3% peas, 1.5% lentils), plant-based protein (5% duckweed protein powder), cereals (3.5% millet), seeds (1.5% sunflower seeds, 0.5% chia seeds), minerals (2% premix), oils and fats (1.4% sunflower oil), algae (0.6% Schizochytrium), yeasts (0.6% brewer's yeast), and plant-based byproducts (0.3% herbs, 0.1% ginkgo, 0.1% nettle).

### Exemplary Embodiment II: Vegan Wet Food for Dogs

The exemplary embodiment II shows a composition of wet (water-containing) ingredients for a vegan wet food that is suitable for adult dogs with a special nutritional requirement (food intolerance, allergy). A portion of the pea protein can be replaced with protein from pillar fungi species.

| Ingredients: | % |
|---|---|
| Duckweed protein | 5.00 |
| Oat flakes | 31.00 |
| Peas | 50.00 |
| Sunflower oil | 4.00 |
| Mineral mixture | 3.00 |
| Kale | 5.00 |
| Ground sunflower seeds | 1.00 |
| Algae | 1.00 |

### Exemplary Embodiment III: Meat-Containing Wet Food for Dogs

The exemplary embodiment III shows a composition of wet (water-containing) ingredients for a meat-containing wet food that is suitable for adult dogs. A portion of the meat can be replaced with in vitro meat.

| Ingredients: | % |
|---|---|
| Beef | 50.00 |
| Rice | 10.00 |
| Zucchini | 8.00 |
| Duckweed protein | 13.00 |
| Kale | 7.00 |
| Apples | 7.00 |
| Rapeseed oil | 2.00 |
| Marine algae | 1.00 |
| Mineral mixture | 2.00 |

### Exemplary Embodiment IV: Vegetarian Dry Food for Dogs

The exemplary embodiment IV shows a composition of ingredients for a vegetarian dry food that is suitable for adult dogs.

| Ingredients: | % |
|---|---|
| Lentils | 19.10 |
| Peas | 28.80 |
| Sweet potatoes | 16.90 |
| Duckweed protein | 9.80 |
| Whole egg powder | 10.00 |
| Carob | 3.00 |
| Rapeseed oil | 2.80- |
| Sunflower oil | 2.50 |
| Linseed | 2.00 |
| Mineral mixture | 2.40 |
| Brewer's yeast extract, | 1.00 |
| hydrolyzed | |
| Carrot | 1.00 |
| Brewer's yeast | 0.50 |
| Blueberries | 0.10 |
| Pumpkin | 0.10 |

### Exemplary Embodiment V: Vegan Dry Food for Dogs

The exemplary embodiment V shows a composition of the ingredients for a vegan dry food that is suitable for adult dogs.

| Ingredients: | % |
|---|---|
| Lentils | 29.10 |
| Peas | 28.80 |
| Sweet potatoes | 16.90 |
| Duckweed protein | 9.80 |
| Carob | 3.00 |
| Rapeseed oil | 2.80- |
| Sunflower oil | 2.50 |
| Linseed | 2.00 |
| Mineral mixture | 2.40 |
| Brewer's yeast extract, | 1.00 |
| hydrolyzed | |
| Carrot | 1.00 |
| Brewer's yeast | 0.50 |
| Blueberries | 0.10 |
| Pumpkin | 0.10 |

### Exemplary Embodiment VI. Meat-Containing Dry Food for Dogs

The exemplary embodiment VI shows a composition of the ingredients for a meat-containing dry food that is suitable for adult dogs.

| Ingredients: | % |
|---|---|
| Potato flakes | 48.00 |
| Dried chicken meat | 15.00 |
| Potato protein | 15.00 |
| Duckweed protein | 10.00 |
| Sunflower oil | 2.50 |
| Sugar beet molasses | 2.50 |
| Liver hydrolysate | 2.00 |
| Apple pomace | 2.00 |
| Rapeseed oil | 2.00 |
| Yeast | 1.00 |

### Exemplary Embodiment VII

The exemplary embodiment VI shows a food analytical examination of 3 different vegetarian wet foods, each including a protein supplement from different sources (pea protein, lentil protein, duckweed protein), wherein the food is suitable as a complete food for adult dogs.

Various foods were produced using a method according to the present teachings; food 1 was supplemented with pea concentrate (isolate) (5 weight %), food 2 was supplemented with cooked lentils, and food 3 was supplemented with duckweed protein concentrate (5 weight %). Crude nutrient analysis was performed to determine the fractions of crude protein, crude fat, crude ash, crude fiber, and NFE. Determination of the mineral proportion and the vitamins was performed using atomic spectroscopy or chemical titration methods. Amino acid analysis was performed using HPLC/NIRS/IC.

The following basic assumptions have been made for the determined requirements for dog and cat: dog: 40 kg, cat 4 kg.

| | | | | | | | Need to cover limiting AA in g | | | |
|---|---|---|---|---|---|---|---|---|---|---|
| | | Content per 100 g | | | | | | | Lemna | Lemna |
| | | | | Lemna | | | | | minor | minor |
| | | | | minor | Need per day | | Pea | | protein | protein |
| | | Pea | | protein | Dog | Cat | protein | Lentils | isolate | isolate |
| | Unit | protein | Lentils | isolate | 20 kg | 4 kg | Dog | Dog | Dog | Cat |
| Water | % | 9 | 12 | 4 | | | | | | |
| Crude | % | 55 | 23 | 45 | | | | | | |
| protein | | | | | | | | | | |
| Crude fat | % | 3 | 1 | 6 | | | | | | |
| Crude ash | % | 6 | 2 | 6 | | | | | | |
| Crude fiber | % | 2 | 3.9 | | | | | | | |
| NFE | % | 25 | 58 | | | | | | | |
| Calcium | mg | 90 | 70 | | 1230 | | | | | |
| Phosphorus | mg | 840 | 340 | | 923 | | | | | |
| Sodium | mg | 900 | 4 | | 246 | | | | | |
| Magnesium | mg | 220 | 110 | | 185 | | | | | |
| Potassium | mg | 1960 | 800 | | 1230 | | | | | |
| | mg | | | | | | | | | |
| Manganese | mg | 2.5 | 1.4 | | 1.5 | | | | | |
| Copper | mg | 1.5 | 1.2 | | 1.8 | | | | | |
| Zinc | mg | 5.9 | 1 | | 18.5 | | | | | |
| Iodine | μg | — | 10 | | 271 | | | | | |
| Iron | mg | 8.5 | 9.3 | | 9.2 | | | | | |
| Chloride | mg | — | | 0 | 369 | | | | | |
| Vitamin A | IU | — | — | | 1554 | | | | | |
| Vitamin D | IU | — | — | 0 | 167 | | | | | |
| Vitamin E | mg | — | 3 | 0 | 9 | | | | | |
| B1 | mg | — | 0.42 | | 0.69 | | | | | |
| B2 | mg | — | 0.26 | | 1.6 | | | | | |
| B6 | mg | — | 0.2 | | 0.46 | | | | | |
| B12 | μg | — | — | 0 | 11 | | | | | |
| Biotin | μg | — | 10 | | 2 | | | | | |
| Niacin | mg | — | 2 | | 5 | | | | | |
| Pantothenic | mg | — | 2 | | 4.61 | | | | | |
| acid | | | | | | | | | | |
| Arginine | g | 3.14 | 0.615 | 4.8 | 1.04 | 0.5 | 33.12 | 169.11 | 21.67 | 10.42 |
| Histidine | g | 1.84 | 0.187 | 1.5 | 0.59 | 0.16 | 32.07 | 315.51 | 39.33 | 10.67 |
| Isoleucine | g | 3.92 | 0.35 | 3.7 | 1.13 | 0.28 | 28.83 | 322.86 | 30.54 | 7.57 |
| Methionine + | g | 0.92 | 0.132 | 2.5 | 2 | 0.21 | 217.39 | 1515.15 | 80.00 | 8.40 |
| Cysteine | | | | | | | | | | |
| Leucine | g | 6.52 | 0.561 | 7.3 | 2.08 | 0.6 | 31.90 | 370.77 | 28.49 | 8.22 |
| Lysine | g | 5.02 | 0.545 | 5 | 1.04 | 0.21 | 20.72 | 190.83 | 20.80 | 4.20 |
| Phen/Tyr | g | 6.92 | 0.639 | 7.5 | 2.3 | 1 | 33.24 | 359.94 | 30.67 | 13.33 |
| Threonine | g | 2.46 | 0.311 | 4 | 1.3 | 0.3 | 52.85 | 418.01 | 32.50 | 7.50 |
| Tryptophan | g | 0.78 | 0.07 | 0.36 | 0.4 | 0.08 | 51.28 | 571.43 | 111.11 | 22.22 |
| Valine | g | 4.06 | 0.421 | 4.6 | 1.5 | 0.3 | 36.95 | 356.29 | 32.61 | 6.52 |

### Determination of the Protein Quality

The protein quality of the animal feed composition can be determined using various known methods of food analysis (e.g., Lebensmittelanalytik [Food analysis]2013, Matissek ed.)

For the preparation, the food to be tested is dried as needed, and ground in a laboratory mill equipped with a 1 millimeter sieve. The dry substance can be assessed gravimetrically, by refractometry, or by pycnometry. In the gravimetric assessment of the dry substance, the foodstuff to be assessed is dried in a laboratory oven using the drying parameters 105° C., 8 hours (AOAC, 2008). The crude protein determination is then effected according to one of the methods known to the skilled person, for example, according to Kjeldahl or Dumas, wherein the nitrogen content determined analytically using the method is converted into the protein content of the sample using a corresponding correction factor (in the average case 6.25) that depends on the protein composition of the sample.

Individual amino acids and their percentage distribution in a composition can be identified and assessed, for example, using classical amino acid analysis using ion exchange liquid chromatography or using high-performance liquid chromatography (HIPLC).

For assessing the quality of a given protein or a mixture, knowledge of the amino acid present in the food protein in the lowest concentration (=limiting amino acid) is required. With the aid of the Amino Acid Index (AAI), the quality of the protein can be estimated according to

$$AAI = ( \{ … , \frac{\% Content {AA}_{i , T}}{\% Content {AA}_{i , R}} * 100 , … \} )$$

wherein AA_{i,T}=amino acidᵢ or amino acid groupᵢ in the test protein T with 1≤i≤n, AA_{i,R}=amino acidᵢ or amino acid groupᵢ in the reference protein R with 1≤i≤n, and n=number of amino acids or amino acid groups in the reference protein.

Using the Essential Amino Acid Index (EAAI), the contribution of the essential amino acids overall for determining the protein quality of a named (particular) protein or a mixture is determined according to:

EAAI=10^{log EAA}

wherein: log EAA=0.1 [log(a_{1T}/a_{1R}*100)+log(a_{2T}/a_{2R}*100)+log(a_{nT}/a_{nR}*100)] is with a_{1T} . . . a_{nT} amino acids in the test protein, and with a_{1R} . . . a_{nR} amino acids in the reference protein, Oser (1959).

The total content of essential amino acids (E/G) is determined from the quotient of the nitrogen amount from the essential amino acids in the protein source and the amount of the total nitrogen in the protein source.

While the above-mentioned methods express statements about the protein quality of a test protein in comparison to a reference protein, the quality of the protein obtained from a particular organism can be assessed using the methods described below.

The Protein Efficiency Ratio (PER) represents the quotient of the body weight increase achieved with the addition of a test protein, and the amount of protein (g) consumed. To calculate the PER, young animals receive a standardized food composition, wherein 10 weight % of the composition consists of test protein. Over a certain period of time, the weight increase is determined and compared to the amount of test protein consumed. For example, the PER for the milk protein casein is 2.5, i.e., per 1 g consumed casein a young rat's body weight increases by 2.5 g.

The biological value (BV) of proteins indicates how much of the absorbed nitrogen is used in the body for the maintenance and growth of muscle mass. In particular, the biological value is determined from

$$Biological Value = \frac{{N}_{ing , T} - ( {N}_{fec , T} - {N}_{fec , R} ) - ( {N}_{uri , T} - {N}_{uri , R} )}{{N}_{ing , T} - ( {N}_{fec} , T - {N}_{fec , R} )} * 100$$

with N_{ing,T}=nitrogen absorbed from test food protein, N_{fec,T}=nitrogen from the test protein eliminated fecally, N_{fec,R}=nitrogen from the protein-free reference diet eliminated fecally, N_{uri,T}=nitrogen from the test food protein eliminated with the urine, and N_{uri,R}=nitrogen from the protein-free reference diet eliminated with the urine. For the assessment, the test subjects are set to the absolute nitrogen minimum using a protein-free diet, then the protein to be tested is added and the nitrogen balance is determined. The biological value of whey protein falls, for example, at 104; that of chicken whole-egg protein at 100. Cow's milk has a BV of 91; casein a BV of 77. Soy protein has a BV of 61.

The net protein utilization (net protein utilization) indicates how much of the absorbed nitrogen is retained in the organism and used for the maintenance and building of muscle mass.

$$Net Protein Utilization = \frac{{N}_{ing , T} - ( {N}_{fec , T} - {N}_{fec , R} - ( {N}_{uri , T} - {N}_{uri , R} )}{{N}_{ing , T}} * 100$$

The retained nitrogen amount is placed in relation with the total amount of nitrogen contained in the food protein. To determine the net protein utilization, the analysis of animal cadavers is often used.

The corrected Amino Acid Index already mentioned above is usually referred to as the Protein Digestibility-Corrected Amino Acid Score (PDCAAS). The true digestibility of an ingested protein is determined based on the nitrogen contained, i.e., the digestibility refers to the ratio of absorbed nitrogen to ingested nitrogen. However, since the absorbed nitrogen cannot be directly measured, it is calculated from the difference between ingested and fecally eliminated nitrogen, i.e., according to

$$true digestibility = \frac{{N}_{ing , T} - ( {N}_{fec , T} - {N}_{fec , R} )}{{N}_{ing , T}}$$

wherein N_{ing,T}=ingested nitrogen of the test protein, N_{fec,T}=fecally eliminated nitrogen of the test protein, and N_{fec,R}=fecally eliminated nitrogen with a protein-free reference diet. In the determining of the real digestibility, the proteins produced by the microflora in the large intestine, the endogenous protein secretion in the gastrointestinal tract, and bacterial fermentation in the large intestine are taken into account (ascertainable using the reference diet). PDCAAS values fall between 0 and 1, wherein the upper value is truncated at 1. The PDCAAS values for cow's milk, chicken egg whites, whey protein, and isolated soy protein fall, for example, at 1; for beef, soy flour, and pea protein concentrate (isolate) between 0.92 and 0.89; for peas at 0.6; for peanuts and rice between 0.52 and 0.5.

Still more precise is the determining of the corrected amino acid index of essential amino acids (Digestible Indispensable Amino Acid Score, DIAAS).

The calculation of the DIAAS is effected using

$$DIAAS = ( \{ … , \frac{\% Content {AA}_{i , T} * {TID}_{i , T}}{\% Content {AA}_{i , R}} * 100 , … \} )$$

wherein AA_{i,T}=essential amino acid in the test food protein with 1≤i≤n, AA_{i,R}=essential amino acidᵢ or amino acid groupᵢ in the reference protein with 1≤i≤n, TID_{i,T}=true ileal digestibilityᵢ of the amino acidᵢ in the test food protein with 1≤i≤n; and n=number of amino acids or amino acid groups in the reference protein.

In contrast to the corrected Amino Acid Index, the essential amino acids are set into relation to one another in the DIAAS, and in addition the true ileal digestibility is also taken into account. Here the ileal digestibility refers to the digestibility of the corresponding amino acid determined in the terminal ileum, taking into account the endogenous secretion of amino acids occurring in the small intestine (for example, using a probe). As also with the calculation of the Amino Acid Index and of the corrected Amino Acid Index (PDCAAS), also in the case of the DIAAS only the smallest result, i.e., that of the limiting amino acid or amino acid group, is conclusive for the valuation of the protein.

### Determination of the Amino Acid Bioavailability

From the digestibility, which allows assertions to be made about what percentage is absorbed over an ingesting distance in the intestinal tract, the bioavailability is different for amino acids. This indicates the proportion of the ingested food that is present in a chemical form, which is suitable for metabolism or the protein biosynthesis. The amino acid bioavailability cannot be directly measured; the amino acid digestibility is provided as an estimate for the amino acid bioavailability (Stein et al., 2009). In particular with respect to the amino acids lysine, methionine, and cysteine, the bioavailability is often overestimated, since these amino acids can be present in a form that precludes a complete utilization in metabolism (chemical change due to the effect of heat and oxidation during the production process; Hendricks, 2017).

### Determination of Palatability: Relative Acceptance Test

A relative acceptance test (RAT) tests the acceptance of a food relative to its comparison food. The test is based on a defined group of dogs (n=X); wherein small, medium-sized and large dogs belong to the group. Feeding times: twice a day: the foods were fed in parallel over 3 to 14 days. Food amount for small dogs: 150 g/d, medium-sized dogs: 300 g/d, large dogs: 450 g/d.

Palatability was determined based on at least 3-5 characteristic values, e.g.: amount eaten (g): average value of the amount of the product offered that was eaten at a single mealtime. Refusals: Number of mealtimes in percentage wherein none of the offered food was eaten. Subjective appeal: average assessment on a scale of 1-5 of the perception of the owner of the preference of the animal for the meal.

### Feeding Tests

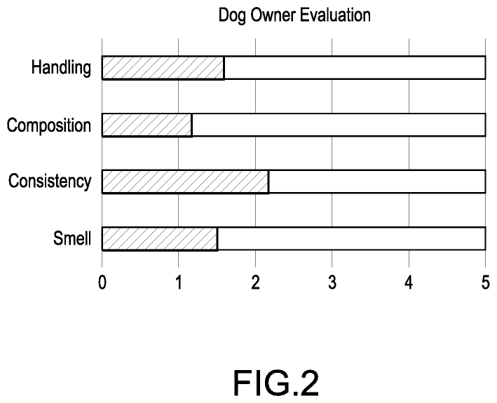

In a simple feeding test (based on the relative acceptance test described above), taste and digestibility can be determined. N=6 dogs (age: 1-8 years; n=3 female, n=3 male; different breeds, all fed with a vegetarian dry food) were fed over 8 to 14 days three times daily with a vegan wet food containing duckweed protein. The sensory characteristics of the test food were investigated. With respect to the dog owner, an assessment was requested of smell, consistency, handling of the food, as well of the evaluation of the composition on a scale of 1=very good to 5=unsatisfactory. Results shown in FIG. 2: a “good” to “very good” assessment was given for all requested parameters.

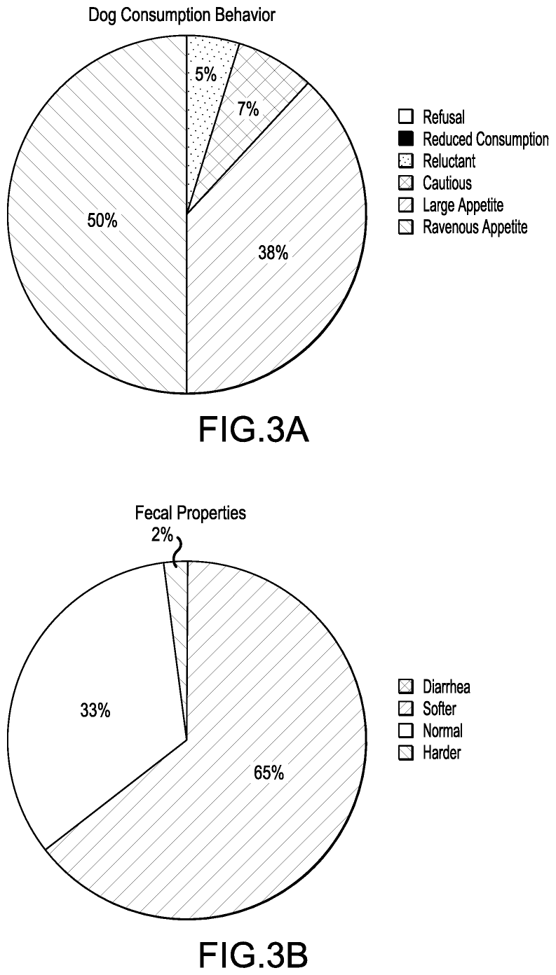

With respect to the animal that was fed, the food intake was observed on at least 8 consecutive days. The following factors were evaluated: refusal of the food, significantly reduced intake, reluctant consumption, cautious appetite, large appetite, ravenous appetite. Results shown in FIG. 3A: in >80% of the feedings, the food was consumed with a “large appetite” or “ravenous appetite.” Refusals and significantly reduced consumption were not observed. Peculiarities after food consumption were also requested about, e.g., gagging, regurgitation, abdominal pain, licking, discomfort, eating noisily. No peculiarities were observed; an improved appetite could be subjectively ascertained above all in the two older dogs examined (>8 years).

The tolerability of the food was determined by an evaluation of the stool consistency and the frequency of defecation. The stool consistency was recorded as “d”-diarrhea, “w”-softer consistency than with the usual diet, “n” normal consistency, and “h” harder consistency than with the usual diet. Peculiarities such as, for example, blood or mucous admixtures were also recorded. Results shown in FIG. 3B: in over 90% of the cases, a normal to softer consistency of the stool was indicated. Diarrhea and other peculiarities were not observed. In all tests, a slightly increased stool frequency was observed.

Examples and embodiments of the present invention were described above. Of course, it is not possible to describe all possible combinations of components or methods to illustrate the present invention, but it is within the ability of the skilled person to carry out additional combinations according to the present invention. The present invention accordingly comprises all such alternatives, modifications, and variations that fall in the area of application of the appended claims.

1. An animal feed composition comprising:
a. 5 to 60 weight % protein content relative to the dry weight of the composition, the protein content comprising protein obtained from the family of duckweeds (Lemnaceae),
b. 0.5 to 65 weight % carbohydrates relative to the dry weight of the composition; and
c. 0.001 to 5 weight % fiber relative to the dry weight of the composition.

2. The animal feed composition according to claim 1, wherein <50 weight % of the protein content consists of protein concentrate obtained from duckweeds, and >50 weight % of the protein content comprises one or more plant-based, non-duckweed protein sources, and/or a plurality of animal-based protein sources and/or protein from fungi, and/or from in vitro meat.

3. The animal feed composition according to claim 1, wherein 1 to 99 weight % of the protein content consists of protein from duckweeds, and additionally comprises amino-acid-optimized protein from pillar fungi species (Basidiomycota) or mold and/or in-vitro meat.

4. The animal feed composition according to claim 1, wherein the animal feed composition is an entirely plant-based animal feed composition.

5. The animal feed composition according to claim 1, wherein the animal feed composition has a corrected Amino Acid Index of at least ≥0.9.

6. The animal feed composition according to claim 1, wherein the animal feed composition has an apparent protein digestibility of at least ≥70%.

7. The animal feed composition according to claim 2, wherein the protein from duckweeds is selected from a group consisting of isolated duckweed protein, duckweed protein concentrate, ground duckweeds, or combinations thereof.

8. The animal feed composition according to claim 1, wherein the protein originates from duckweeds of the genus Lemna, Wolffiella, or Wolffia, or combinations thereof.

9. The animal feed composition according to claim 1, additionally comprising 1 to 10 weight % of a fat.

10. The animal feed composition according to claim 9, wherein the fat is one or more plant-based oils selected from the group consisting of sunflower oil, algae oil, chia seed oil, sesame oil, evening primrose oil, pumpkin seed oil, grapeseed oil, sallow thorn oil, rose hip kernel oil, argan oil, black caraway oil, borage oil, apricot kernel oil, almond oil, peanut oil, linseed oil, linseed crush, camelina oil, olive oil, rapeseed oil, corn oil, hazelnut oil, hemp oil, rice germ oil, safflower oil, soybean oil, palm oil, coconut oil, walnut oil, or combinations thereof.

11. The animal feed composition according to claim 1, additionally comprising 0.01 to 3 weight % of a mineral supplement.

12. The animal feed composition according to claim 1, additionally comprising:
0.01 to 2.0 weight % amino acids, and
essential nutrients.

13. The animal feed composition according to claim 12, wherein the amino acids are selected from the group consisting of methionine, cysteine, threonine, tryptophan, or combinations thereof.

14. The animal feed composition according to claim 1, further comprising a protein selected from the group consisting of a wheat protein, a rye protein, a barley protein, an oat protein, a rapeseed protein, a lupine protein, a pea protein, a rice protein, a soy protein, a millet protein, an amaranth protein, an arrowroot protein, a chia protein, a buckwheat protein, a manioc protein, a chickpea protein, a peanut protein, a potato protein, a sunflower protein, a tapioca protein, or combinations thereof.

15. The animal feed composition according to claim 1, wherein carbohydrates are selected from the group consisting of buckwheat carbohydrate, spelt carbohydrate, amaranth carbohydrate, quinoa carbohydrate, wheat carbohydrate, millet carbohydrate, rye carbohydrate, barley carbohydrate, oat carbohydrate, maize carbohydrate, rice carbohydrate, potato carbohydrate, and combinations thereof.

16. A method for producing the animal feed composition according to claim 1, comprising:
a) mixing of protein from the family of the duckweeds (Lemnaceae) with carbohydrates, and with fiber, in a liquid phase.

17. The method according to claim 16, additionally comprising one or more of:
b) adding amino-acid-optimized protein from pillar fungi species (Basidiomycota) or mold species, and/or from in vitro meat;
c) increasing the dry substance of the liquid phase;
d) addition amino acids in a liquid phase and obtaining of a liquid composition;
e) addition water-soluble minerals to obtain a supplemented composition;
f) addition fat and homogenization with the liquid or supplemented composition; and/or
g) drying the liquid composition or the supplemented composition.

18. The method according to claim 16, wherein step a) comprises mixing protein from the family of the duckweeds with cereal- and/or potato-carbohydrates, and with vegetable fiber in a liquid phase.

19. A method comprising feeding an animal feed composition comprising 5 to 60 weight % protein content relative to the dry weight of the composition, the protein content comprising protein obtained from the family of duckweeds (Lemnaceae), and having a corrected amino acid index of at least 0.9; 0.5 to 65 weight % carbohydrates relative to the dry weight of the composition, and 0.001 to 5 weight % fiber with reference to the dry weight of the composition, to a pet or to an animal kept in a zoological facility as a complete feed.

20. The method according to claim 19, wherein the animal composition is fed as a complete food for a house pet or a small animal.

21. The animal feed composition according to claim 1, wherein the protein from duckweeds comprises isolated duckweed protein, duckweed protein concentrate, or a combination thereof.
